(19) United States
(12) Patent Application Publication
(10) Pub. No.: US 2007/0284300 A1
(43) Pub. Date: Dec. 13, 2007

(54) Removing material from liquid sample within a sample vessel

(76) Inventors: Brian A. Bidlingmeyer, Frazer, PA (US); Alan D. Broske, West Chester, PA (US); William E. Barber, Landenberg, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/450,190

(22) Filed: Jun. 8, 2006

(51) Int. Cl. B01D 27/00

(52) U.S. Cl. 210/450; 210/511; 210/490; 210/473; 422/101; 436/178; 422/63

(57) ABSTRACT

An apparatus and method for filtering a liquid sample. A vessel defines a reservoir. An insert is at least partially and slidably positioned within the reservoir. The insert defines a collection volume, and the collection volume is in fluid communication with the reservoir. A separation element is positioned to partition the collection volume from the reservoir.

### BACKGROUND

Membrane filters and solid-phase extraction (SPE) beds are commonly used to separate or otherwise remove material (e.g., analytes, particles, solutes, and other matter) from liquid samples that need further analysis, which is commonly accomplished using techniques such as chromatography and spectrometry. When removing material from liquid samples, a scientist or lab technician typically passes a sample from a first storage vessel, through a filter and/or a SPE bed, and into a second sample vessel. This process requires multiple, separate pieces of lab equipment that needs cleaning. It is time consuming and expensive.

### SUMMARY

In general terms, the present invention relates to a vessel and a separation element that fits within the vessel to remove material from a liquid sample within the vessel.

One aspect of the invention provides an apparatus for removing material from a liquid sample. The apparatus comprises a vessel defining a reservoir. An insert is at least partially and slidably positioned within the reservoir. The insert defines a collection volume, and the collection volume is in fluid communication with the reservoir. A separation element is positioned to partition the collection volume from the reservoir.

Another aspect of the invention provides an apparatus for removing material from a liquid sample. The apparatus comprises a vessel defining a reservoir. An insert is at least partially and slidably positioned within the reservoir, and the insert defines a collection volume. The collection volume is in fluid communication with the reservoir. The insert has an outer surface and the vessel has an inner surface, and the outer surface of the insert substantially conforms to the inner surface of the vessel. A separation element is positioned to partition the collection volume from the reservoir. A seal is positioned between the outer surface of the insert and the inner surface of the vessel. A cap is positioned adjacent to the opposite end portion of the insert. The cap includes a septum.

Yet another aspect of the invention provides a method of removing material from a liquid. The method comprises providing a liquid sample in a vessel; positioning an insert in the vessel, the insert including a separation element and defining a collection volume; and urging the insert through the vessel and forcing the liquid sample through the separation element.

### BRIEF DESCRIPTION OF THE DRAWINGS

FIG. 1 is a cross-sectional view of an exemplary apparatus having a vessel, insert, and separation element.

FIG. 2A is a cross-sectional view of the insert and separation element illustrated in FIG. 1.

FIG. 2B is a cross-sectional view of an alternative embodiment of the insert and separation element illustrated in FIG. 1.

FIG. 3 is a cross-sectional view of the insert and separation element illustrated in FIG. 1 together with a cap.

FIGS. 4A-4C are cross-sectional views of the apparatus illustrated in FIG. I being used.

FIG. 5 is a view of the apparatus illustrated in FIG. 1 being used with an autosampler.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

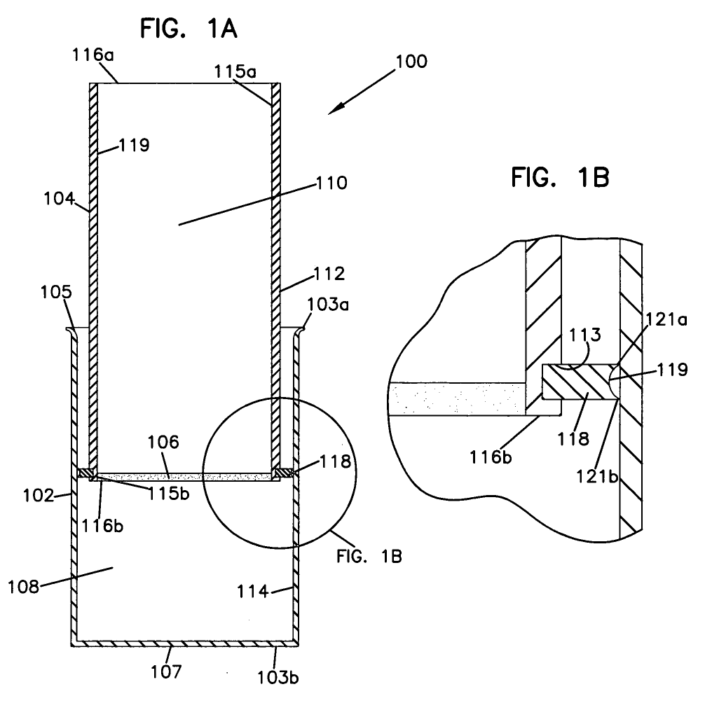

Referring to FIG. 1, the exemplary embodiment of an apparatus 100 for removing material from a liquid sample includes a vessel 102, an insert 104, and a separation element 106. The vessel 102 is generally cylindrical and defines a reservoir 108. The vessel 102 has an inner surface 114, an upper end portion 103a that defines an opening 105, and a lower end portion 103b that has a bottom 107.

The insert 104 defines a collection volume 110. The collection volume 110 is in fluid communication with the reservoir 108. The insert 104 is generally cylindrical has an outer surface 112. The outer surface 112 of the insert 104 substantially conforms to the inner surface 114 of the vessel 102. In other possible embodiments, the outer surface 112 of the insert 104 and the inner surface 114 of the vessel 102 have non-cylindrical or even non-conforming shapes, although these alternative embodiments have a structure that prevents liquid from following between the inner surface 114 of the vessel 102 and the outer surface 112 of the insert 104. Although particular structures for a vessel 102 and an insert 104 are illustrated in the exemplary embodiment, other embodiments might use different structures and configurations. Additionally, the shapes and dimensions of the vessel 102 and the insert 104 can vary depending on needs for various volume samples or the needs of various instrumentation and equipment that interfaces with the vessel 102 and insert 104.

The insert 104 has upper and lower end portions 116a and 116b, respectively, that define openings 115a and 115b, respectively. The insert 104 is slidably positioned within the reservoir 108 and arranged so that the lower end portion 116b is positioned within the vessel 102 and the upper end portion 116a projects through the opening 105 of the vessel 102. In this exemplary embodiment, the upper end portion 116a of the insert 104 will project from the vessel 102 when the lower end portion 116b of the insert 104 is directly adjacent to the bottom 107 of the vessel 102.

The outer surface 112 of the insert 104 defines a groove 113 that extends around the circumference of the insert 104. The groove 113 forms a seat for a seal 118, which is describe in more detail herein. In the exemplary embodiment, the groove 113 is positioned proximal to the lower end portion 116b. Additionally, the separation element 106 is positioned proximal to the lower end portion 116b. The separation element 106 is positioned to partition the collection volume 108 from the reservoir 110. Although particular configurations for the insert 104 and the separation element 106 are illustrated in the exemplary embodiment, other embodiments might use different structures and configurations.

In one possible embodiment, the vessel 102 and insert 104 are made from tempered glass that can be heated for cleaning and sterilization. Other embodiments use other materials to form the vessel 102 and/or insert 104.

A seal 118 is seated in the groove 113 and is positioned between the insert 104 and the inner surface 114 of the vessel 102. One possible example is that the seal 118 can be fixed to the outer surface 112 of the insert 104. The shape and dimensions of the seal 118 can vary depending on the shapes of the vessel 102 and the insert 104. In the exemplary embodiment, for example, the seal 118 has a concave surface 119 that forms upper an lower edges 121a and 121b. In another possible embodiment, the seal 118 is a simple o-ring that has a round cross section. Although the seal 118 is illustrated as being seated in the groove 117, another possible embodiment positioned the seal 118 directly against the outer surface 112 of the insert 104 and the inner surface 114 of the vessel 102. The seal 118 may be adhered with an adhesive to the insert 104

One possible example of a material that can be used to form the seal 118 is rubber. In other possible embodiments, the seal 118 can be made from different types of material. Although particular structure and configuration for the seal 118 are illustrated in the exemplary embodiment, other embodiments might use different structures and configurations.

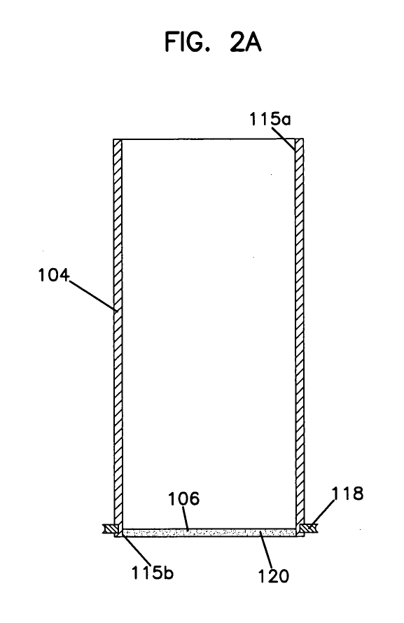

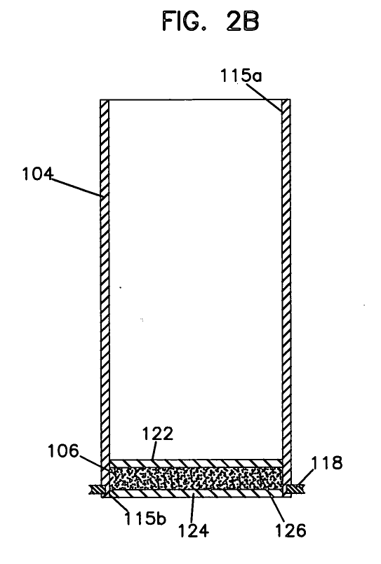

Referring to FIG. 2A, possible embodiments of the separation element 106 include a filter element such as a membrane that covers the opening 115b defined by the lower end portion 116b of the insert 104. In various embodiments, the separation element 106 can be adhered with an adhesive to the inner surface 119 of the inert 104 or directly to the end portion 116b. In other possible embodiments, the separation element 106 is wrapped around the end portion 116b and engages the outer surface 112 of the insert 104. In this embodiment, the separation element 106 also may be adhered to the outer surface 112 with an adhesive. In yet other possible embodiments, the separation element 106 is mounted on an annular frame (not shown) that attaches the separation element 106 to the insert 104.

In the exemplary embodiment, the separation element 106 is a membrane having a plurality of pores 120 or perforations. A possible pore size is typically about 0.45 microns. The size of the pores can be in one possible range of about 0.25 microns to about 1 micron. Examples of materials that can be used to form the membrane include nylon, PTFE, and any other material commonly used to make porous membranes. Although particular material, structure, and configurations for the separation element 106 are illustrated in the exemplary embodiment, other embodiments might use different material, structures and configurations.

Referring to FIG. 2B, other possible embodiments of the separation element 106 include a separation bed 126 retained between upper and lower layers 122 and 124, respectively. In various embodiments, the separation be can be formed with active and/or passive materials. Solid-phase extraction (SPE) material is an example of one type of material that can be used to form the separation bed 126. In this exemplary embodiment, the SPE material is used to absorb material from the mixture in which the liquid sample, including the desired material, is passed through the SPE material forming the separation bed 126. The undesired material is extracted from the liquid sample and retained within the SPE material. Examples of materials that can be used to form the separation bed 126 include bonded-phased silica; silica; carbon; or any porous or nonporous, inorganic or organic particles. These particles may be chemically modified or unmodified. Other possible embodiments include other suitable material for filtering or otherwise removing undesired material from a sample.

The upper and lower layers 122 and 124 can be any porous structure for retaining the separation bed 126 such as membranes, gratings, or perforated sheets. The first and second layers 122 and 124 are porous or in the form of a grating to allow liquid to pass and can be made from any material suitable for SPE, including polyethylene and stainless steel. Additionally, the upper and lower layers 122 and 124 can function as filters as well and cooperate with the separation bed 126 to separate undesired material from the liquid sample.

In the exemplary embodiment, the upper and lower layers 122 and 124 and the separation bed 126 are mounted in a frame (not shown) that attaches to the insert 104. In other embodiments, the upper and lower layers 122 and 124 are adhered to the inner surface 119 of the insert 104.

Although particular material, structure and configurations for the separation element 106 and/or the separation bed 126 are illustrated in the exemplary embodiment, other embodiments might use different material, structures and configurations.

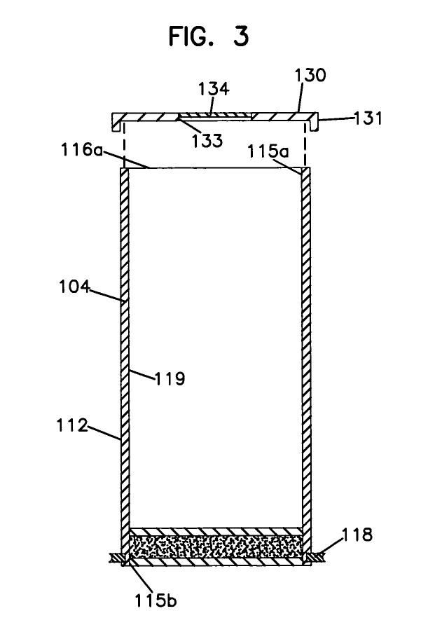

Referring to FIG. 3, in the exemplary embodiment a cap 130 is formed with a frame 131 that defines a hole 133 that can have any size. A septum 134 is attached to the frame 131 and covers the hole 133.

The frame 131 attaches to the upper end portion 116a of the insert 104. In various embodiments, the cap 130 is either permanently or removably connected to the insert 104. Examples of mechanisms to attach the cap 130 to the insert 104 include threads, frictional engagement, a snap fit, and adhesive. Alternatively, the cap 130 can simply rest on the upper end portion 116a of the insert 104 or fit inside of the insert 104 and engage the inner surface 119 similar to a stopper for a test tube. The septum 134 is formed with a material that reseals if is it pierced with a needle or similar structure. Examples of such materials include rubber and rubber mixtures containing substances such as silicone, plasticizers, organometallics, and the like. In alternative embodiments, there is no frame and a septum extends over the entire opening 115a at the upper end portion 116a of the insert 104. In this embodiment, the septum 134 can be connected to the inner or outer surface 119 or 112 of the insert 105. Yet other possible embodiments do not include a cap or septum to cover the opening at the upper end portion of the insert. Although particular structure and configurations for the cap 130 and the septum 134 are illustrated in the exemplary embodiment, other embodiments might use different structures and configurations.

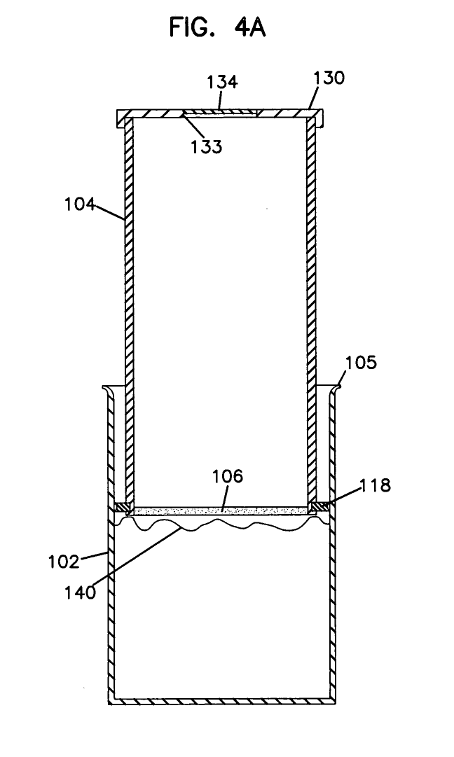

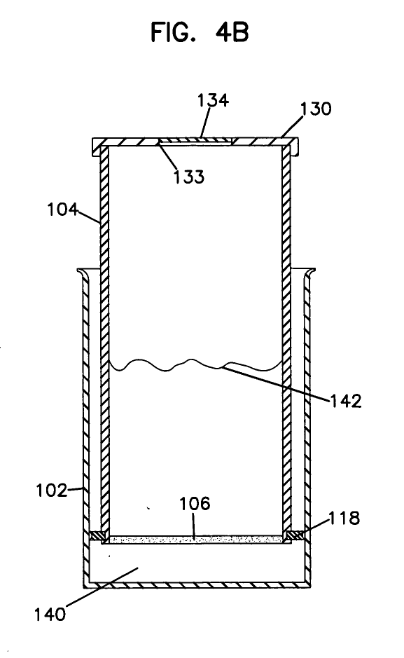

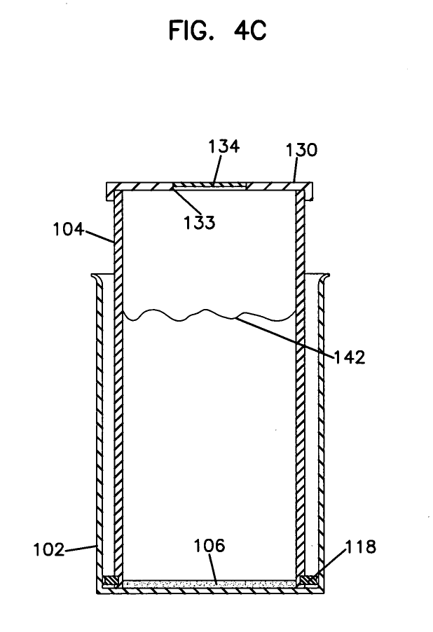

In use, referring to FIGS. 4A-4C, in one possible embodiment, a liquid sample 140 is provided in the vessel 102. The lower end portion 116b of the insert 104 is positioned in the reservoir 108 of the vessel 102. The cap 130 is attached to the upper end portion of the insert 104, and the insert 104 is urged through the vessel 102 so that the separation element 104 presses against the liquid sample 140. The cap 130 provides a surface for a user to press against, prevents the liquid sample 140 from splashing out of the collection volume 110, and prevents contamination of the liquid sample 140. The pressure exerted by the separation element 106 against the liquid sample 140 forces it to flow through the separation element 106 and into the collection volume 110. The separation element 106 prevents undesired material from passing though the separation element 106 and into the collection volume 110. Desired material passes though the separation element 106 with the liquid sample 140 and into the collection volume 110. Liquid passing through the separation element 106 forms a flow-though liquid sample 142.

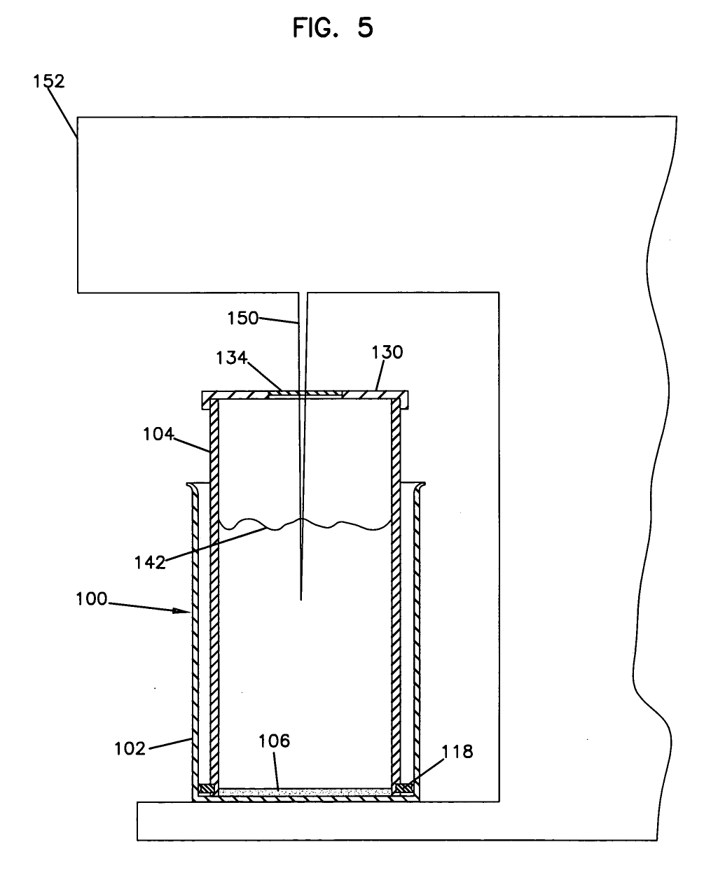

Referring to FIG. 5, the flow-through liquid sample 142 can be withdrawn or otherwise removed from the collection volume 110. In one possible embodiment, the apparatus 100 is inserted into an autosampler system 152 and a needle 150 from the autosampler system 152 pierces the septum 134 and flow-through liquid sample 142 is withdrawn from the collection volume 110 and through the needle 150 for analysis of the flow-through liquid sample 142 and/or material contained within the flow-through liquid sample 142. Although an autosampler 152 is illustrated in the exemplary embodiment, the liquid sample 142 can be withdrawn from the collection volume 110 with out the cap 130 in place, with instruments other than an autosampler, or manually. Additionally, flow-through liquid sample 142 can be withdrawn with devices other than needles, such as pipettes. In yet other embodiments, the liquid can be analyzed within the collection volume 110 itself.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. An apparatus for removing material from a liquid sample, the apparatus comprising:
a vessel defining a reservoir;
an insert at least partially and slidably positioned within the reservoir, the
insert defining a collection volume, the collection volume in fluid communication with the reservoir; and
a separation element positioned to partition the collection volume from the reservoir.

2. The apparatus of claim 1 wherein the separation element is made from material selected from the group consisting of: nylon, PTFE, and combinations thereof.

3. The apparatus of claim 1 wherein the separation element has a plurality of pores, the pores having a size in the range of about 0.25 microns to about 1 micron.

4. The apparatus of claim 1 wherein the separation element comprises:
first and second layers, the first layer being spaced from the second layer; and
a filter material is positioned between the first and second membranes.

5. The apparatus of claim 5 wherein the filter material includes a material selected from the group consisting of: nylon, PTFE, and combinations thereof.

6. The apparatus of claim 5 wherein the filter material is a solid-phase extraction material.

7. The apparatus of claim 6 wherein the solid-phase extraction material includes a material selected from the group consisting of: bonded-phased silica, silica, carbon, and combinations thereof.

8. The apparatus of claim 6 wherein the solid-phase extraction material includes an active material.

9. The apparatus of claim 6 wherein the solid-phase extraction material includes a passive material.

10. The apparatus of claim 1 wherein the insert has an outer surface and the vessel has an inner surface, the outer surface of the insert substantially conforming to the inner surface of the vessel.

11. The apparatus of claim 10 further comprising a seal positioned between the outer surface of the insert and the inner surface of the vessel.

12. The apparatus of claim 1 wherein the insert has oppositely disposed end portions, and the separation element is positioned adjacent to one end portion.

13. The apparatus of claim 12 further comprising a cap, the cap being positioned adjacent to the opposite end portion of the insert.

14. The apparatus of claim 13 wherein the cap includes a septum.

15. An apparatus for removing material from a liquid sample, the apparatus comprising:
a vessel defining a reservoir;
an insert at least partially and slidably positioned within the reservoir, the insert defining a collection volume, the collection volume in fluid communication with the reservoir, wherein the insert has an outer surface and the vessel has an inner surface, the outer surface of the insert substantially conforming to the inner surface of the vessel;
a separation element positioned to partition the collection volume from the reservoir;
a seal positioned between the outer surface of the insert and the inner surface of the vessel; and
a cap, the cap being positioned adjacent to the opposite end portion of the insert, the cap including a septum.

16. A method of removing material from a liquid, the method comprising:
providing a liquid sample in a vessel;
positioning an insert in the vessel, the insert including a separation element and defining a collection volume; and
urging the insert through the vessel and forcing the liquid sample through the separation element.

17. The method of claim 16 wherein urging the insert through the vessel and forcing the liquid sample through the separation element includes:
blocking material from passing through the separation element and into the collection volume.

18. The method of claim 16 wherein urging the insert through the vessel and forcing the liquid sample through the separation element includes:
extracting material from the liquid sample passing through the separation element and into the collection volume.

19. The method of claim 16 wherein liquid passing through the separation element forms flow-through liquid, the method further comprising:
withdrawing the liquid from the collection volume.

20. The method of claim 19 further comprising:
withdrawing the liquid from the collection volume using an autosampler.
